(19) United States
(12) Patent Application Publication
(10) Pub. No.: US 2018/0156682 A1
(43) Pub. Date: Jun. 7, 2018

(54) EVENT-BASED DYNAMOMETER DUTY CYCLE

(71) Applicant: GM GLOBAL TECHNOLOGY OPERATIONS LLC, Detroit, MI (US)

(72) Inventors: Brian R. Goodman, Brighton, MI (US); Jeffrey S. Rayce, Royal Oak, MI (US); Timothy A. Grzadzinski, Dexter, MI (US)

(21) Appl. No.: 15/490,277

(22) Filed: Apr. 18, 2017

Related U.S. Application Data
(60) Provisional application No. 62/429,467, filed on Dec. 2, 2016.

(51) Int. Cl. G01L 5/26; G01M 17/007; G01L 3/04

(52) U.S. Cl. CPC G01L 5/26; G01M 17/007; B60Y 2304/00; F16C 2233/00; G01L 3/04

(57) ABSTRACT

A method for testing a component includes mounting a first component on a dynamometer, and controlling the dynamometer to perform a dynamometer duty cycle event that includes exerting torque and speed over time on the first component that is substantially similar to torque and speed exerted over time on a second component during a vehicle testing event.

### CROSS REFERENCE TO RELATED APPLICATION

This patent application claims priority to U.S. provisional Application No. 62/429,467, filed Dec. 2, 2016, which is hereby incorporated herein by reference in its entirety.

### INTRODUCTION

The subject invention relates to testing automotive driveline components and other rotating components. Driveline components include, for example, drive shafts, axles, couplings, and other rotating components that are operative to provide torque to the wheels of a vehicle.

Driveline components are tested to ensure that the components will meet or exceed a duty cycle design specification as part of a durability test.

Driveline components may be tested, for example, by installing a component on a test vehicle and driving the vehicle in a testing environment to determine the duty cycle of the component. The rotating components may also be tested using a dynamometer that rotates the component at a speed and subjects the component to a torque.

A dynamometer (dyno) is a device that measures torque and rotational speed of a rotating component or machine. Dynamometers may also be used to induce or exert force, torque, or power on a rotating machine or component. Dynamometers often include motors, motor controllers, and sensors that provide for a device that exerts a desired torque at a desired rotational speed on a component or machine.

It is desirable to provide an improved duty cycle testing system using a dynamometer.

### SUMMARY

In one exemplary embodiment, a method for testing a component includes mounting a first component on a dynamometer, and controlling the dynamometer to perform a dynamometer duty cycle event that includes exerting torque and speed over time on the first component that is substantially similar to torque and speed exerted over time on a second component during a vehicle testing event.

In addition to one or more of the features described herein, or as an alternative, further embodiments include the first component being substantially similar to the second component.

In addition to one or more of the features described herein, or as an alternative, further embodiments include the dynamometer duty cycle event that is operative to simulate on the first component, varying torque and speed over time that was exerted on the second component during the vehicle testing event.

In addition to one or more of the features described herein, or as an alternative, in further embodiments, the first component includes a vehicle driveline component.

In addition to one or more of the features described herein, or as an alternative, further embodiments include the dynamometer being operative to exert a varying torque and speed on the first component.

In addition to one or more of the features described herein, or as an alternative, further embodiments include performing the vehicle testing event on the second component prior to controlling the dynamometer to perform the dynamometer duty cycle event.

In addition to one or more of the features described herein, or as an alternative, further embodiments include the vehicle testing event includes using sensor data to collect and store torque and speed exerted on the second component while the second component is mounted in a vehicle and the vehicle is being operated during the vehicle testing event.

In another exemplary embodiment, a testing system includes a dynamometer, and a processor communicatively connected to the dynamometer. The processor is operative to control the dynamometer to perform a dynamometer duty cycle event that includes exerting torque and speed over time on a first component mounted in the dynamometer that is substantially similar to torque and speed exerted over time on a second component during a vehicle testing event.

In addition to one or more of the features described herein, or as an alternative, further embodiments include the first component being substantially similar to the second component.

In addition to one or more of the features described herein, or as an alternative, further embodiments the dynamometer duty cycle event is operative to simulate on the first component varying torque and speed over time that was exerted on the second component.

In addition to one or more of the features described herein, or as an alternative, further embodiments include wherein the vehicle testing event includes using sensor data to collect and store torque and speed exerted on the second component while the vehicle is being operated during the vehicle testing event.

In addition to one or more of the features described herein, or as an alternative, further embodiments include wherein the first component includes a vehicle driveline component.

In addition to one or more of the features described herein, or as an alternative, further embodiments include wherein the dynamometer is operative to exert a torque and speed on the first component.

In yet another exemplary embodiment, a method for controlling a dynamometer includes exerting torque and speed over time on a first component mounted in the dynamometer that is substantially similar to torque and speed exerted over time on a second component during a vehicle testing event. The vehicle testing event includes operating a vehicle while the second component is mounted in the vehicle and collecting torque and speed data from sensors that sense torque and speed of the second component.

In addition to one or more of the features described herein, or as an alternative, further embodiments, the first component is substantially similar to the second component.

In addition to one or more of the features described herein, or as an alternative, further embodiments, wherein the dynamometer duty cycle event is operative to simulate on the first component, torque and speed over time that was exerted on the second component.

In addition to one or more of the features described herein, or as an alternative, further embodiments the first component includes a vehicle driveline component.

In addition to one or more of the features described herein, or as an alternative, further embodiments include wherein the dynamometer is operative to exert a torque and speed on the first component.

In addition to one or more of the features described herein, or as an alternative, further embodiments include performing the vehicle testing event on the second component prior to controlling the dynamometer to perform the dynamometer duty cycle event.

In addition to one or more of the features described herein, or as an alternative, further embodiments include wherein the vehicle testing event includes using sensor data to collect and store torque and speed exerted on the second component while the second component is mounted in a vehicle and while the vehicle is being operated during the vehicle testing event.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a block diagram of an exemplary embodiment of a component testing system;

FIG. 2 illustrates a block diagram of a data gathering system. The data gathering system includes component sensors that are positioned in a vehicle;

FIG. 3 includes a graph that includes a speed plot and a torque plot of an example of a vehicle testing event;

FIG. 4 illustrates a graph that includes a speed plot and a torque plot; and

FIG. 5 illustrates a block diagram of an exemplary method of operation of the system of FIG. 1.

### DETAILED DESCRIPTION

The following description is merely exemplary in nature and is not intended to limit the present disclosure, its application or uses. It should be understood that throughout the drawings, corresponding reference numerals indicate like or corresponding parts and features.

The methods and systems described herein provide for an improved method for testing components on a dynamometer that realistically simulates duty cycle events. A duty cycle event is an event that may occur during the duty cycle of a component. For example, an axle may experience torque at a particular rotational speed during a duty cycle event.

Previous methods for testing components on a dynamometer use a block cycle test method that tested the components at a first torque and a first rotational speed for a first time period. After the first time period expires, the component is tested at a second torque and a second rotational speed for a second time period, and so on. Such block cycle testing does not simulate realistic duty cycle events using the dynamometer.

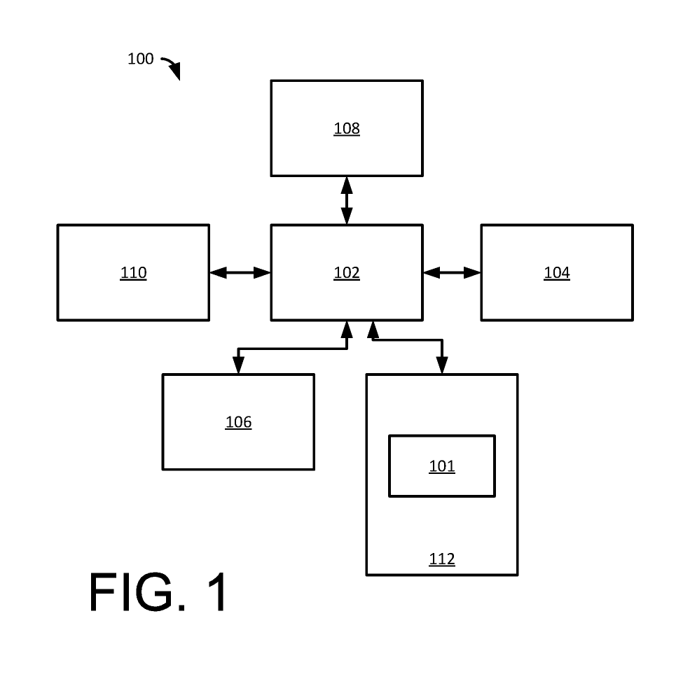

In accordance with an exemplary embodiment, FIG. 1 illustrates a block diagram of an exemplary embodiment of a component testing system (test system) 100. The test system 100 uses gathered vehicle testing event data, which includes torque and speed that varies over time that a vehicle component 101 is subjected to during all, of or a portion of, the vehicle testing event to simulate the testing event on the component 101 using the dynamometer 112.

The use of the dynamometer 112 to simulate the torque and speed induced on a component in a vehicle during a vehicle testing event provides an improved testing method. In this regard, more realistic, efficient and effective component testing using a dynamometer is achieved by testing a component on the dynamometer 112 using varying torque and speed over time that simulates, or substantially corresponds to, the varying torque and speed measured on the component during a vehicle testing event.

The test system 100 includes a processor 102 that is communicatively connected to a memory 104, a display 106, an input device 108, a network 110, and the dynamometer 112. A component 101 is mounted to the dynamometer 112.

The component 101 in the illustrated exemplary embodiment may include, for example, any driveline component such as, drive shafts, axles, wheels, brake components, couplings, associated fasteners and any other components that are operative to provide power to the wheels of a vehicle. Besides driveline components, the component 101 may include any other type of rotating component of a vehicle that may be subjected to a durability test.

In operation, the processor 102 of the test system 100 is operative to control the dynamometer 112 by providing either a data file with testing instructions for the dynamometer 112 to process and perform, or by sending a control signal to the dynamometer 112 to control a testing event. The control of the dynamometer 112 will be described in further detail herein.

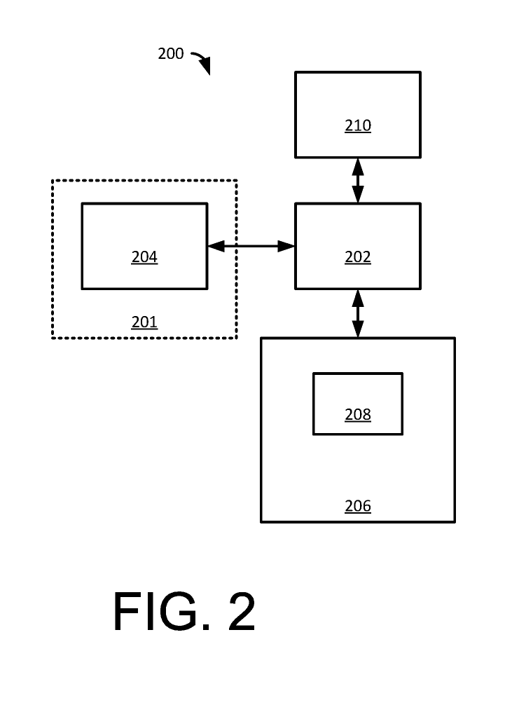

FIG. 2 illustrates a block diagram of a data gathering system 200. The data gathering system 200 includes component sensors 204 that are positioned in a vehicle 201. The component sensors 204 may include, for example, position sensors, speed sensors, torque sensors or any other suitable sensors or processors that are operative to sense a torque and rotational speed of a rotating component on the vehicle 201.

The component sensors 204 may be communicatively connected to a processor 202 via a wired or wireless connection. The processor 202 may receive and process data from the sensors 204 as the component sensors 204 are operating. Alternatively, the component sensors 204 may operate on the vehicle 201, and gather and store the testing data on the vehicle 201. Following the vehicle test, the data 208 may be retrieved from the sensors 204 with the processor 202 by establishing a communicative connection between the processor 202 and the component sensors 204.

The processor 202 is communicatively connected to a memory 206 that stores the sensor data 208 from the component sensors 204. The processor 202 is also communicatively connected to an input/output (I/O) device or devices 210.

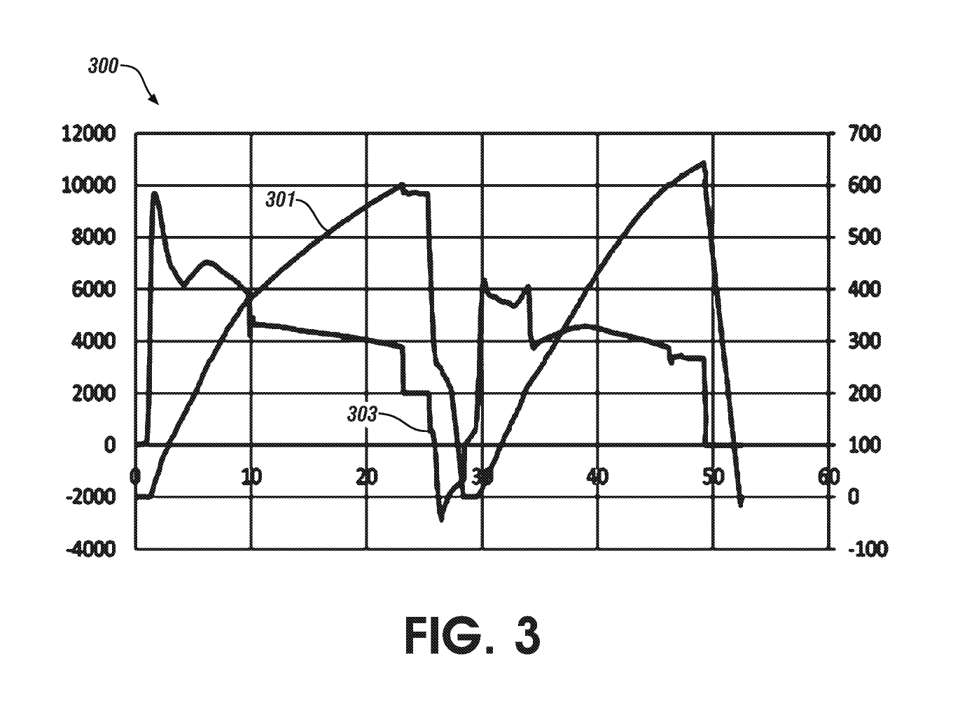

FIG. 3 includes a graph 300 that includes a speed plot 301 and a torque plot 303 of an example of a vehicle testing event. In this regard, the torque and speed data over time of a vehicle component 101 in a vehicle was gathered by the system 200 (of FIG. 2) during a vehicle testing event. During a vehicle testing event, a vehicle is operated in a manner that replicates real world operating conditions such as, for example, driving the vehicle on a test course while sensors gather data (e.g., torque and speed data) from components on the vehicle.

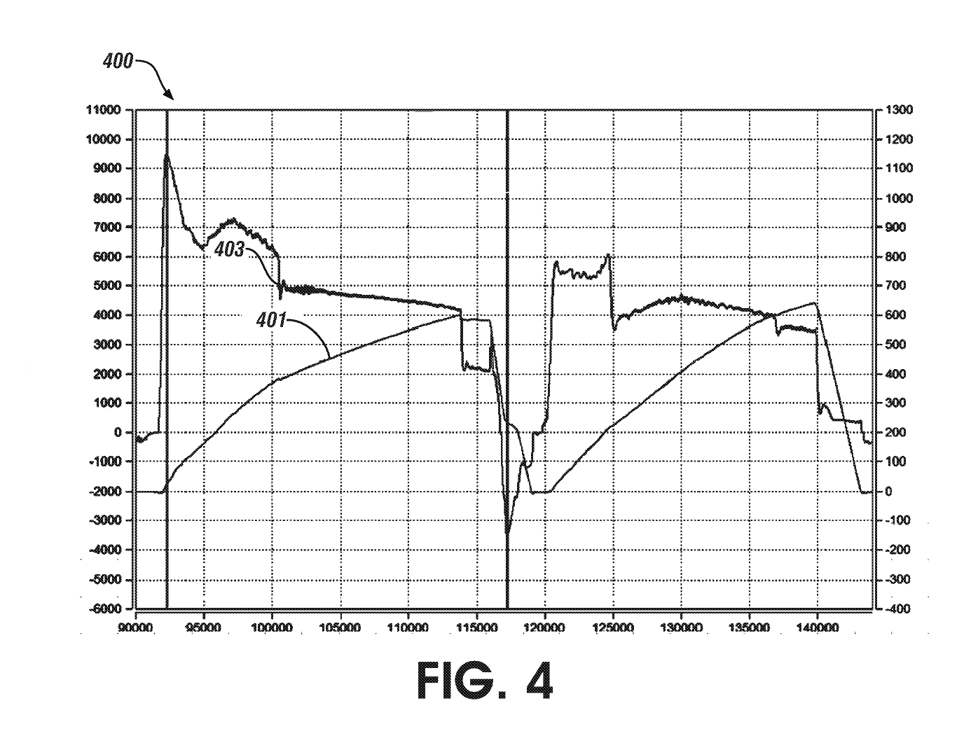

FIG. 4 illustrates a graph 400 that includes a speed plot 401 and a torque plot 403. The graph 400 shows the speed and torque over time that the dynamometer 112 (of FIG. 1) will subject the vehicle component 101 to during a dynamometer duty cycle event. In this regard, the particular torque and speed that is applied to the component 101 during the dynamometer duty cycle event is substantially the same as the torque and speed that was measured by the system 200 (of FIG. 2) during the vehicle testing event described above.

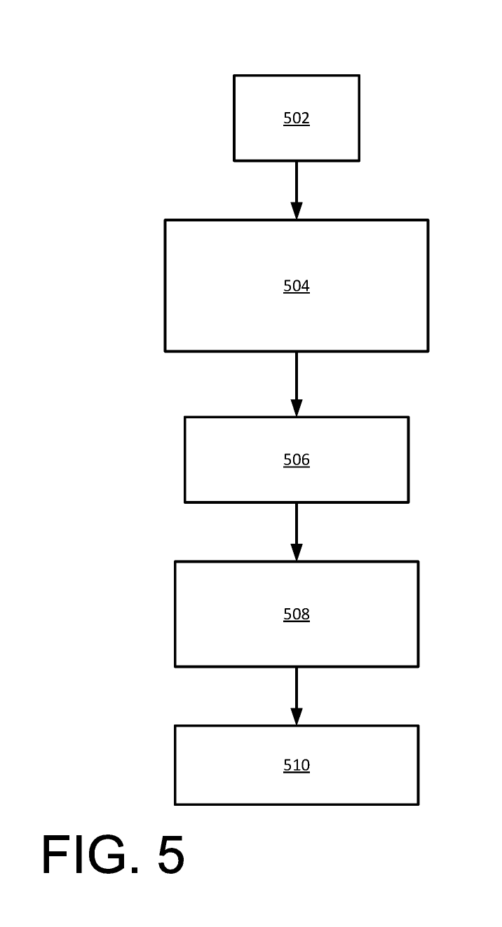

FIG. 5 illustrates a block diagram of an exemplary method of operation of the system 100 described above. In block 502 the vehicle event data is collected, and the vehicle event data is received by the system 100. In block 504, the collected vehicle event data may be converted into a test event program. In block 506, the component 101 is mounted in the dynamometer 112. In block 508 the test event program is run such that the dynamometer 112 induces torque and speed over time on the component 101 that substantially corresponds to or is substantially the same or substantially similar to the collected vehicle event torque and speed data. Following the running of the test event program, the condition of the component 101 may be evaluated in block 510.

The system 100 (of FIG. 1) described above uses the gathered vehicle testing event data to simulate the vehicle testing event on the component 101 using the dynamometer 112.

The use of the dynamometer 112 to simulate the torque and speed experienced by a component on a vehicle during a vehicle testing event provides an improved testing method. In this regard, testing a component on the dynamometer 112 using torques and speeds that simulate or substantially correspond to the torques and speeds measured on the component during a vehicle testing event allows more realistic and effective component testing using a dynamometer. Such a testing system and method provides reduced testing costs while performing a more effective and realistic dynamometer test. Such tests may also reduce the time spent testing the component in vehicle testing events.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A method for testing a component, the method comprising controlling a dynamometer to perform a dynamometer duty cycle event that includes exerting torque and speed over time on the first component that is substantially similar to torque and speed exerted over time on a second component in a vehicle during a vehicle testing event.

2. The method of claim 1, wherein the first component is substantially similar to the second component.

3. The method of claim 1, wherein the dynamometer duty cycle event is operative to simulate on the first component, varying torque and speed over time that was exerted on the second component during the vehicle testing event.

4. The method of claim 1, wherein the first component includes a vehicle driveline component.

5. The method of claim 1, wherein the dynamometer is operative to exert a varying torque and speed on the first component.

6. The method of claim 1, further comprising performing the vehicle testing event on the second component prior to controlling the dynamometer to perform the dynamometer duty cycle event.

7. The method of claim 6, wherein the vehicle testing event includes using sensor data to collect and store torque and speed exerted on the second component while the second component is mounted in a vehicle and the vehicle is being operated during the vehicle testing event.

8. A testing system comprising:
a dynamometer; and
a processor communicatively connected to the dynamometer, the processor operative to control the dynamometer to perform a dynamometer duty cycle event that includes exerting torque and speed over time on a first component mounted in the dynamometer that is substantially similar to torque and speed exerted over time on a second component during a vehicle testing event.

9. The system of claim 8, wherein the first component is substantially similar to the second component.

10. The system of claim 8, wherein the dynamometer duty cycle event is operative to simulate on the first component varying torque and speed over time that was exerted on the second component.

11. The system of claim 8, wherein the vehicle testing event includes using sensor data to collect and store torque and speed exerted on the second component while the vehicle is being operated during the vehicle testing event.

12. The system of claim 8, wherein the first component includes a vehicle driveline component.

13. The system of claim 8, wherein the dynamometer is operative to exert a torque and speed on the first component.

14. A method for controlling a dynamometer, the method comprising exerting torque and speed over time on a first component mounted in the dynamometer that is substantially similar to torque and speed exerted over time on a second component during a vehicle testing event that includes operating a vehicle while the second component is mounted in the vehicle and collecting torque and speed data from sensors that sense torque and speed of the second component.

15. The method of claim 14, wherein the first component is substantially similar to the second component.

16. The method of claim 14, wherein the dynamometer duty cycle event is operative to simulate on the first component, torque and speed over time that was exerted on the second component.

17. The method of claim 14, wherein the first component includes a vehicle driveline component.

18. The method of claim 14, wherein the dynamometer is operative to exert a torque and speed on the first component.

19. The method of claim 14, further comprising performing the vehicle testing event on the second component prior to controlling the dynamometer to perform the dynamometer duty cycle event.

20. The method of claim 19, wherein the vehicle testing event includes using sensor data to collect and store torque and speed exerted on the second component while the second component is mounted in a vehicle and while the vehicle is being operated during the vehicle testing event.
